(19) United States
(12) Patent Application Publication
(10) Pub. No.: US 2008/0313166 A1
(43) Pub. Date: Dec. 18, 2008

(54) RESEARCH PROGRESSION SUMMARY

(75) Inventors: Wei Yu, Redmond, WA (US); Amir Padovitz, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/763,835

(22) Filed: Jun. 15, 2007

(51) Int. Cl. G06F 17/30; G06F 17/00; G06F 7/08

(52) U.S. Cl. 707/5; 707/100; 707/E17.058; 707/7; 707/E17.009

(57) ABSTRACT

Systems, methods, and computer-readable media for generating a research progression summary are provided. A research progression summary provides a snapshot of documents (e.g., articles) that have had a significant impact on a particular field of research, or at least a portion thereof, over time. Research progression sorts through all accessible relevant documents, analyzes the importance of each, and summarizes for presentation only those documents determined to be of particular importance with respect to a topic of interest (i.e., the particular field of research or some portion thereof). In this manner, a researcher can readily determine how the thinking with respect to a particular topic has progressed over time. By way of example only, the research progression summary may focus on one or more of historical developments in a particular field, current developments with respect to a topic of interest, or an overall summary of a particular field/topic.

### BACKGROUND

Existing electronic search technologies retrieve documents using keywords and other familiar search techniques. The main goal of these search technologies is to retrieve all documents that satisfy the search criteria. Some of these search technologies use algorithms to present the search results in an order that reflects the anticipated usefulness to the searcher. For example, some online search engines rank results according to the number of other pages that link to that page.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to systems, methods, and computer-readable media for generating a research progression summary. A research progression summary provides a snapshot of documents, e.g., articles, that have made a significant impact on a particular field of research, or at least a portion thereof, over time. A countless number of documents relevant to a particular topic (i.e., a particular field of research or some portion thereof) is stored in one or more databases. Some documents relevant to a particular topic are more significant than others from the perspective of the academic researcher. However, the significance of a document is often not readily apparent by simply reading it. Research progression, in accordance with embodiments hereof, sorts through all accessible relevant documents, analyzes the importance of each, and summarizes for presentation only those documents determined to be of particular importance. In this manner, a researcher can readily determine how the thinking with respect to a particular topic has progressed over time. A particular research progression summary may focus on the historical developments in a particular field, current developments with respect to a topic of interest, an overall summary of a particular field/topic, or any combination thereof.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary computer system architecture suitable for use in implementing embodiments of the present invention;

FIG. 3 is a schematic diagram illustrating an exemplary research progression summary, in accordance with an embodiment of the present invention;

FIG. 4 is a flow diagram illustrating an exemplary method for generating a research progression summary, in accordance with an embodiment of the present invention;

FIG. 5 is flow diagram illustrating an exemplary method for generating a clustered-ranked-citation link graph, in accordance with an embodiment of the present invention;

FIG. 6 is an schematic diagram illustrating an exemplary research progression summary that presents documents of historical significance in a particular field of research, in accordance with an embodiment of the present invention;

FIG. 7 is schematic diagram, in accordance with an embodiment of the present invention, illustrating an exemplary research progression summary that presents a current state of a particular field of research;

FIG. 8 is a schematic diagram showing an exemplary clustered-ranked-citation link graph, in accordance with an embodiment of the present invention; and

FIG. 9 is schematic diagram showing an exemplary user interface configured to receive the research criteria for generating a research progression summary, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

A research progression summary provides a snapshot of documents, e.g., articles, that have made a significant impact on a particular field of research, or at least a portion thereof, over time. A countless number of documents relevant to a particular topic (i.e., a particular field of research or some portion thereof) is stored in one or more databases. Some documents relevant to a particular topic are more significant than others from the perspective of the academic researcher. However, the significance of a document is often not readily apparent by simply reading it. Research progression, in accordance with embodiments hereof, sorts through all accessible relevant documents, analyzes the importance of each, and summarizes for presentation only those documents determined to be of particular importance. In this manner, a researcher can readily determine how the thinking with respect to a particular topic has progressed over time. A particular research progression summary may focus on the historical developments in a particular field, current developments with respect to a topic of interest, an overall summary of a particular field/topic, or any combination thereof.

Accordingly, in one embodiment, the present invention relates to one or more computer-readable media having computer-executable instructions embodied thereon, that when executed, perform a method of generating a research progression summary for a particular research field. The method includes receiving one or more research criteria, identifying one or more documents that satisfies the research criteria, generating a research progression summary utilizing the identified documents, and storing the generated research progression summary.

In another embodiment, the present invention relates to one or more computer-readable-media having computer-executable instructions embodied thereon, that when executed, perform a method for generating a clustered-ranked-citation link graph. The method includes receiving document information for one or more documents, generating a citation link graph for the one or more documents, categorizing the one or more documents into one or more domains, generating a static rank for each of the one or more documents, and storing the clustered-ranked-citation link graph.

In a further embodiment, the present invention relates to a computerized system for generating a research progression summary for a particular topic. The computerized system includes a receiving module configured for receiving one or more research criteria, a retrieving module configured for retrieving document information from one or more documents, a generating module configured to generate a clustered-ranked-citation link graph, a research progression summary generating module configured to generate a research progression summary, and at least one database configured for storing at least document information from one of the one or more documents and the research progression summary.

Having briefly described an overview of embodiments of the present invention, an exemplary operating environment suitable for use in implementing embodiments of the present invention is described below.

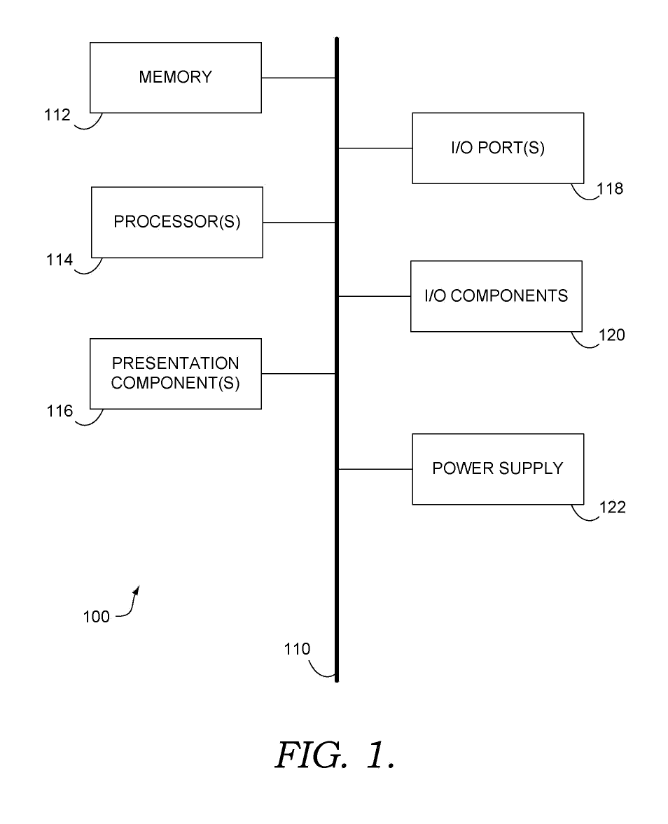

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty computing devices, and the like. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and referred to as “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, and the like.

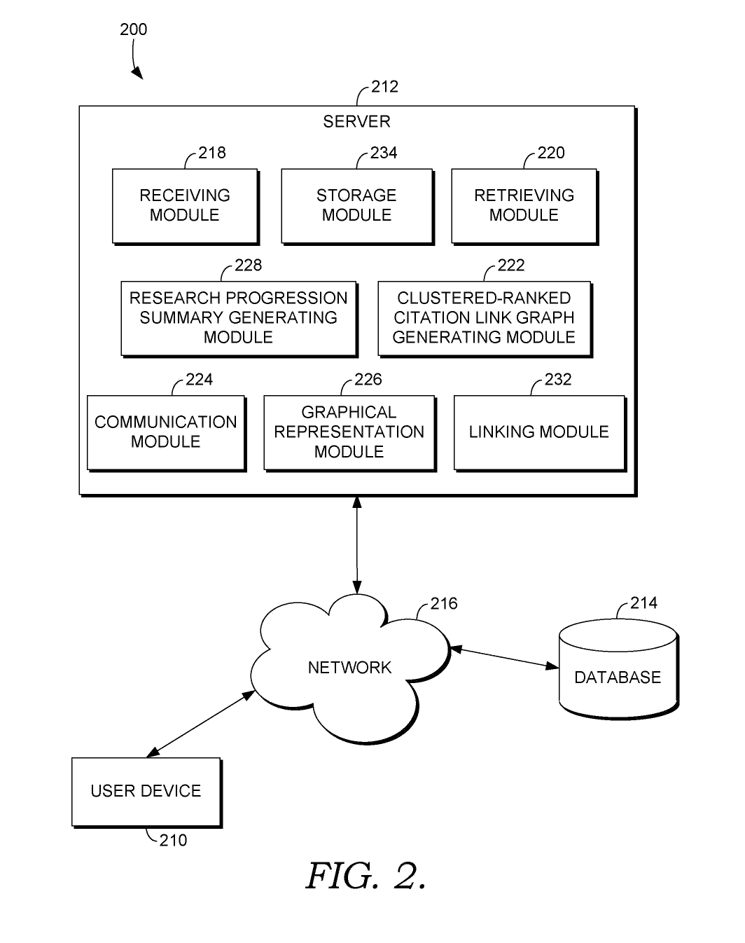

Turning now to FIG. 2, a block diagram is illustrated that shows an exemplary system architecture 200 configured for generating a research progression summary, in accordance with an embodiment of the present invention. It will be understood and appreciated by those of ordinary skill in the art that the computing system architecture 200 shown in FIG. 2 is merely an example of one suitable computing system and is not intended to suggest any limitation as to the scope of the use or functionality of the present invention. Neither should the computing system architecture 200 be interpreted as having any dependency or requirement related to any single component/module or combination of component/modules illustrated therein.

Computing system architecture 200 includes a user device 210, a server 212, and a database 214, all in communication with one another via a network 216. The network 216 may include, without limitation, one or more local area networks (LANs) and/or one or more wide area networks (WANs). Such networking environments are commonplace in offices, enterprise-wide computer networks, intranets, and the Internet. Accordingly, the network 216 is not further described herein.

The database 214 is configured to store documents of interest to researchers and information associated with the documents. In various embodiments, such documents may include, but are not limited to, academic papers, master's theses, Phd. theses, dissertations, articles published in trade journals, articles published in scholarly journals, books, online resources, conference papers, and white papers. This list is not comprehensive, and any document relevant to researchers is contemplated to be within the scope of embodiments hereof. Further, the term “researchers”, as utilized herein, encompasses anyone attempting to access information about a particular topic, including, but not limited to, medical researchers, R&D researchers, students, teachers, professors, engineers, scientists, philosophers, sociologists, journalists, and so on. All fields of interest, ranging from the hard sciences, to the liberal arts are possible topics of research.

In embodiments, the database 214 is configured to be searchable for one or more of the items stored in association therewith. It will be understood and appreciated by the those of ordinary skill in the art that the information stored in the database 214 may be configurable and may include any information relevant to documents. The content and volume of such information are not intended to limit the scope of embodiments of the present invention in any way. Further, though illustrated as a single, independent component, database 214 may, in fact, be a plurality of databases, for instance, a database cluster, portions of which may reside on the end-user device 210, the server 212, another external computing device (not shown), and/or any combination thereof.

Each of the end-user device 210 and the server 212 may be any type of computing device, such as, for example, computing device 100 described above with reference to FIG. 1. By way of example only and not limitation, each of the end-user device 210 and the server 214 may be a personal computer, desktop computer, laptop computer, handheld device, mobile handset, consumer electronic device, or the like. It should be noted, however, that the present invention is not limited to implementation on such computing devices, but rather may be implemented on any of a variety of different types of computing devices within the scope of embodiments hereof.

As shown in FIG. 2, the server 212 includes a receiving module 218, a retrieving module 220, a clustered-ranked citation link graph generating module 222, a communication module 224, a graphical representation module 226, a research progression summary generating module 228, a storage module 230, and a linking module 232. In some embodiments, one or more of the illustrated modules, may be implemented as stand-alone applications. In other embodiments, one or more of the illustrated modules, may be integrated directly into the operating system of the server 212 or the end-user device 210. It will be understood by those of ordinary skill in the art that the modules 218, 220, 222, 224, 226, 228, 230, and 232, illustrated in FIG. 2 are exemplary in nature and in number and should not be construed as limiting. Any number of modules may be employed to achieve the desired functionality within the scope of embodiments of the present invention.

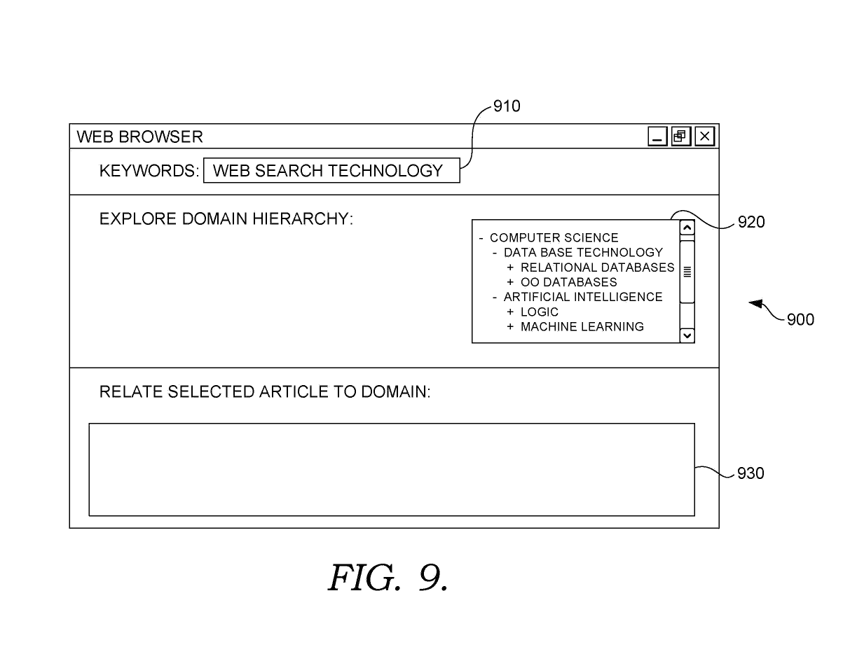

The receiving module 218 is configured for receiving one or more research criteria. In one embodiment, the receiving module is configured to receive the research criteria from the user device 210. Research criteria may be input by a user much like a standard keyword search query may be input, for instance, in association with an appropriate field presented on a graphical user interface, or the like. FIG. 9 shows an exemplary user interface 900 configured to receive three different types of user input, including keywords 910, choosing a domain from a domain hierarchy 920, or entering an existing article known to be within the desired domain 930. In embodiments, the receiving module 218 is configured to receive input from one or more fields in the user interface 900, and fields other than the three described fields could be utilized by the receiving module. It will be understood and appreciated by those of ordinary skill in the art that the receiving module may receive input by virtue of input techniques not involving a graphical user interface as well. For instance, audio recognition techniques and the like may be utilized within the scope of embodiments hereof.

In addition to the subject matter related research criteria, the receiving module 218 is also configured to receive weighing information research criteria (not shown). The weighing information may be used by the research progression summary generating module 228 to customize the research progression to meet the researchers needs. In this way, the researcher can receive a research progression summary that gives more weight to recent documents, documents of historical significance, and anything in between. Additionally, the researcher may chose to give more or less weight to citations from documents in different sub-domains in determining the significance thereof.

The retrieving module 220 is configured to search through one or more databases 214 and retrieve document information from one or more documents. Document information includes, but is not limited to, bibliographic information, citations to other documents, domain classification information, meta data, and information about the documents supplied by the author, publisher, or others that describes or classifies the document. Those of ordinary skill in the art will understand that there are many methods to search for and retrieve document information, all such methods are contemplated to be within the scope of the invention.

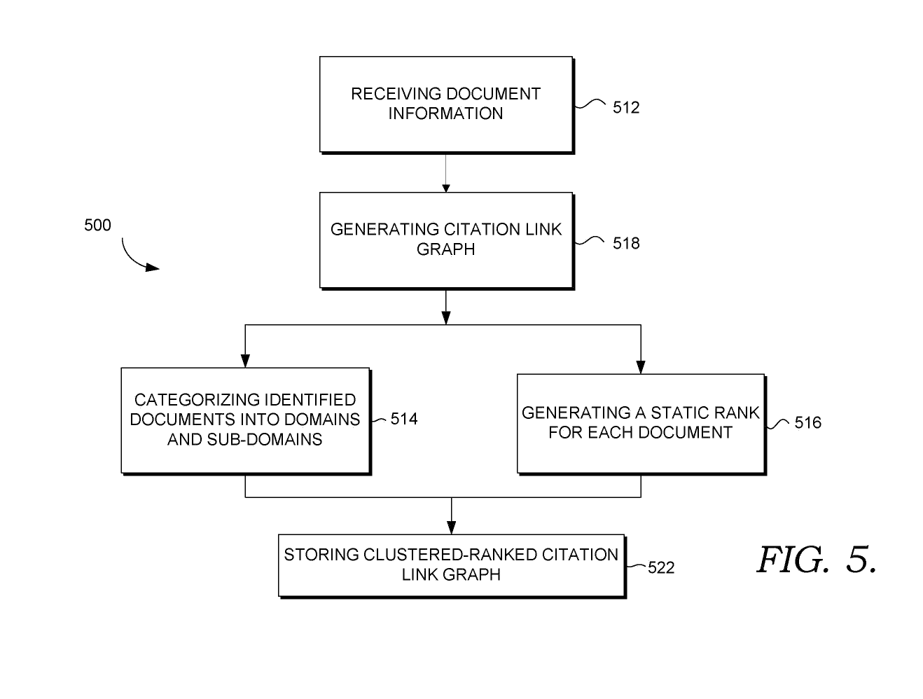

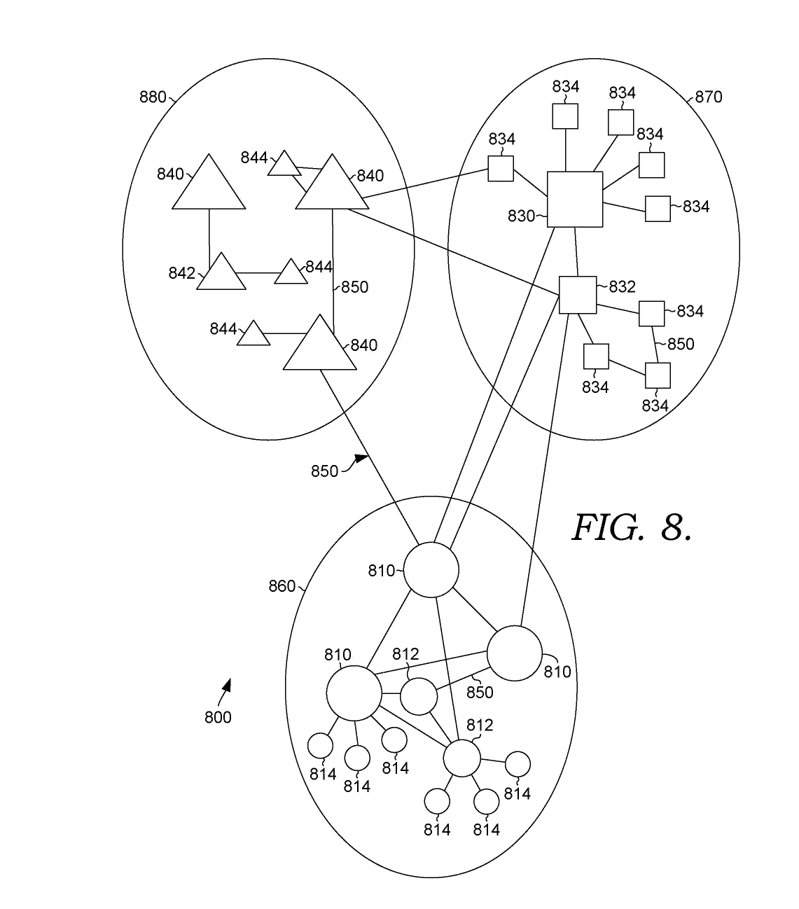

The clustered-ranked citation link graph generating module 222 is configured to generated a clustered-ranked citation link graph. FIG. 8 shows an illustration of a clustered-ranked citation link graph, which will be explained in more detail herein below. Additionally, FIG. 5 goes into more detail about an exemplary method that may be used by the clustered-ranked citation link graph module 222 to generate the illustrated clustered-ranked citation link graph.

The communication module 224, is configured to communicate the research progression summary. The communication module may communicate with a user interface, a printer, e-mail generator or any other known communication means.

The graphical representation module 226 is configured to generate graphical representations to be presented, e.g., displayed, in association with the user device 210. For instance, the graphical representation module 226 may generate a display of the research progression summary, including graphical representations (e.g., icons) representing the important or significant documents selected for inclusion in the research progression summary. Methods of generating graphical representations are well known in the art and all known methods are considered to be within the scope of this invention.

The research progression summary generating module 228 is configured to generate research progression summaries. The research progression summary generating module 228 runs calculations over the clustered-ranked citation link graph, and selects documents that are significant for inclusion in the research progression summary. The research progression summary generating module 228 may take weighing information provided by the researcher into account when determining the relative significance of each document. Based on the weighing-research criteria, the research progression summary generating module will give more weight to certain factors that go into determining a document's significance rank. Specifically, the date of publication can be given more or less weight and the importance of the article within its own sub-domain can be given more or less weight. For example, citations by articles within the same sub-domain could be given more weight than citations by articles in different sub-domains, and even more compared to articles in different domains. In some embodiments, more weight will be given to recent documents than more historical, for example, in response to research criteria specifying a focus on the state of a particular field of research, or some portion thereof.

In embodiments, the research progression generating module 228 may also take into consideration the dates of publication when weighing the significance of a document. For example, documents having earlier publication dates will generally have more citations to them than a document having a later publication date just by virtue of age. Accordingly, looking only at total citations may cause more recently published documents to be excluded. In one embodiment, the significance of a document may be determined using citations per unit of time, such as year, rather than just total number of citations.

The linking module 232 is configured to generate links between the user interface and the actual documents in the database 214, or storage module 230. In one embodiment, upon selecting the link on the user interface the document may be opened in a separate window by software configured to open the document. In one embodiment, upon selecting the link, the user may be prompted to download, email, or print the document, or select other available options. Methods of linking documents and retrieving documents in response are well known in the art and all such methods are considered to be within the scope of the invention.

The storage module 230 is configured to provide storage for all other modules and processes that need temporary or permanent storage. Such items include, but are not limited to, retrieved document information, retrieved documents, the clustered-ranked citation link graph, the complete research progression summary, and all required steps in between.

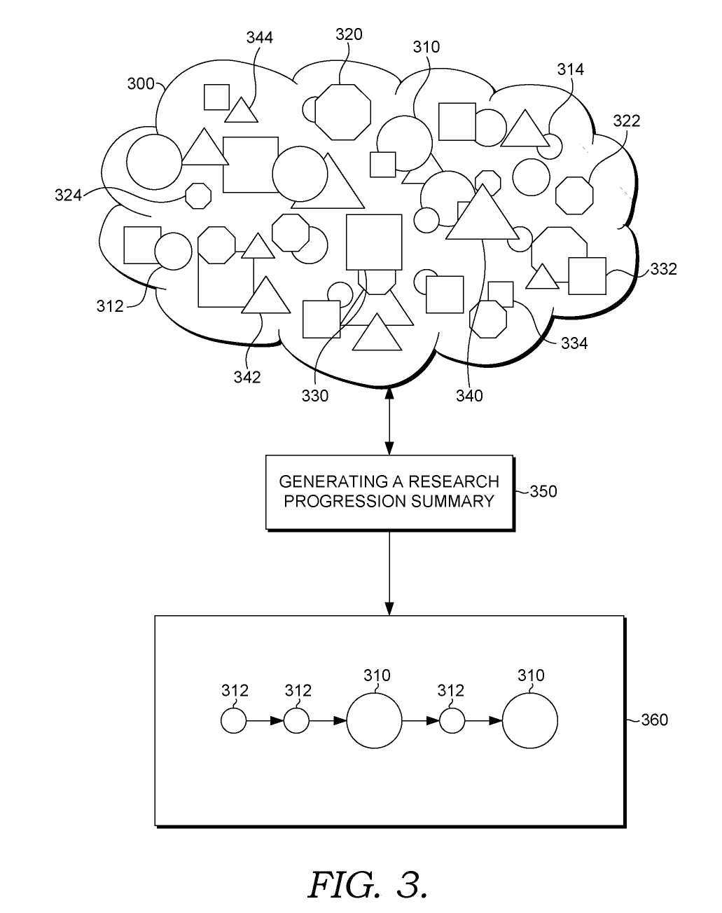

Turning now to FIG. 3, a schematic diagram broadly illustrating a research progression summary 360, and the “raw” data 300 from which it is built are shown. In a typical embodiment, documents are stored in one or more databases 300, in essentially random fashion. Each document can be categorized into one or more research domains or sub-domains. Further, documents within each topic will be of different levels of significance within the research community. The different sized shapes 310, 312, 314, 320, 322, 324, 330, 332, 334, 340, 342, and 344 within the database 300, represent documents on different topics (shapes) and of differing significance (size). Only four topics and three representations of significance are shown for the sake of simplicity. Actual databases could have a virtually unlimited number of topics. Additionally, the significance of actual documents does not necessarily break down readily into significance categories, but exists on a continuum. Further, the document's subject matter and significance is not apparent and can only be determined after analysis. Nevertheless, the documents are represented in 300 as if some analysis had been performed. Determining the subject matter and importance of each article is a step that occurs as part of generating a research progression summary 350.

The details of generating a research progression summary, in accordance with embodiments hereof, are explained subsequently. However, in general, the clustered-ranked citation link graph is analyzed and significant articles within the requested research domain or sub-domain are identified. The research progression summary 360 is generated using at least some of these documents and then presented to the researcher. The number of documents presented in a research progression summary can vary and the five shown in 360 are merely representative of one possible embodiment.

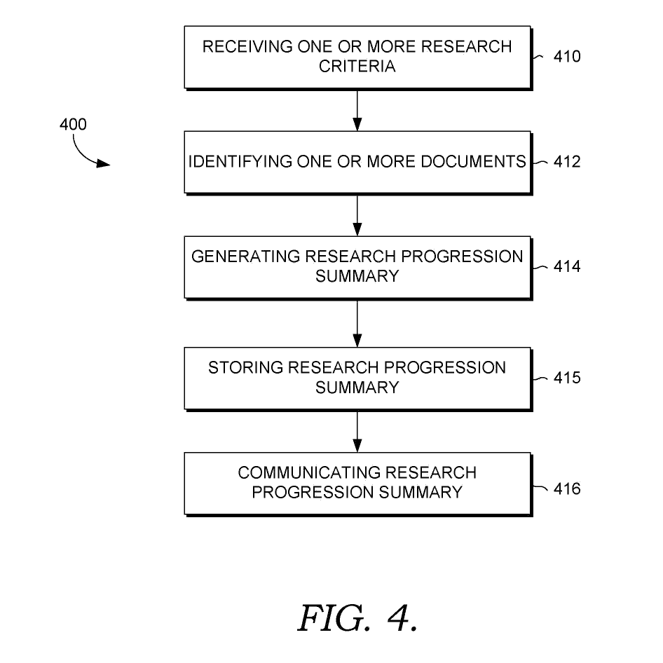

Referring next to FIG. 4, a flow diagram showing an exemplary method for generating a research progression summary is illustrated and designated generally as reference numeral 400. The first step is to receive one or more research criteria 410. In an illustrative embodiment, a researcher may input research criteria to define the scope of the research progression summary. In one embodiment, the researcher may input the research criteria into a user interface 900 on FIG. 9. FIG. 9 shows an exemplary user interface 900 configured to receive three different types of user input, including keywords 910, choosing a domain from a domain hierarchy 920, or entering an existing document known to be within the desired domain 930. These three options are intended to be illustrative and other options are possible including, by way of example only, author, ISBN numbers, publications, and the like.

Next, computations will be run over the clustered ranked citation link graph using the research criteria and relevant documents will be identified 412. The identification algorithm could use any of the aforementioned research criteria, or a combination of research criteria to identify documents meeting the criteria.

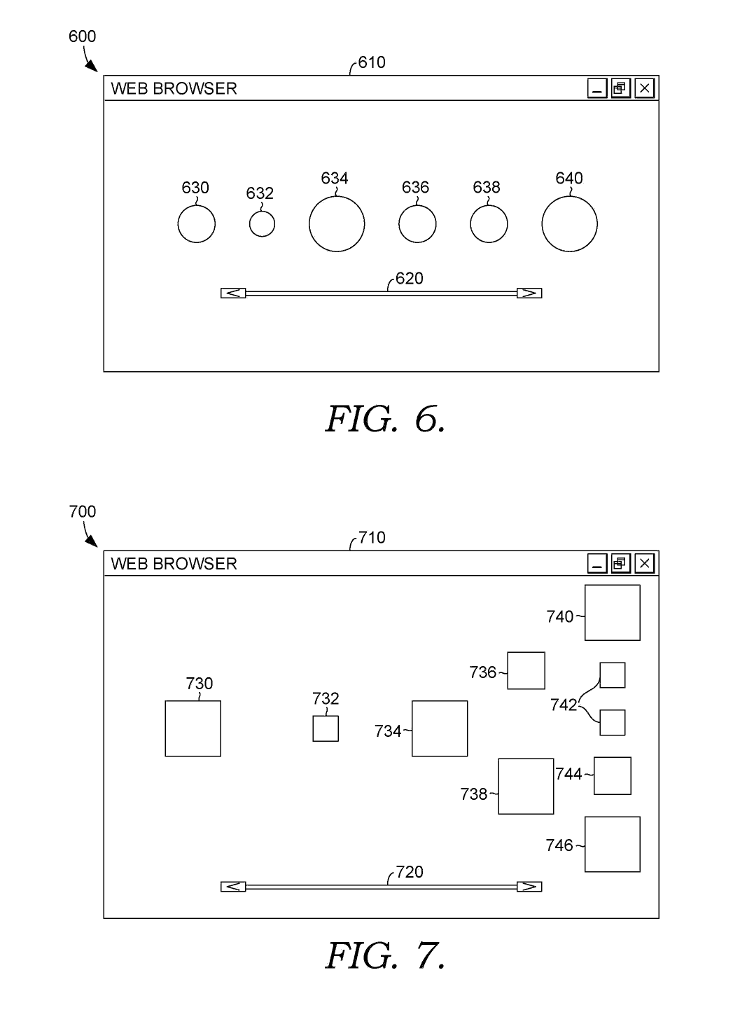

Next, a research progression summary is generated 414. The research progression summary will be explained in more detail with reference to FIGS. 6 & 7. For now, it is sufficient to note that that research progression summary will contain the most significant documents that satisfy the research criteria and be presented in such a way that the chronology of the documents is apparent. The number of documents and selection of documents will vary according to the research criteria received. Possible variations include a pure research progression 600 FIG. 6, a historical progression, and a state of the art research progression 700 FIG. 7. The pure research progression would present significant documents where the significance is determined without regard for time. For example, the six most important documents of all time could form the substance of a pure research progression summary. The historical variation would select documents that reflect the early thinking in the research field. Finally, the state of the art variation FIG. 7, would present more recent documents. In one embodiment, the documents selected for inclusion within the research progression are presented so that the chronology of the documents is apparent. In an illustrative embodiment, the user interface includes a scroll bar 620 and 720 so the research may scroll through icons 620, 622, 624, 626, 628, and 630 on FIGS. 6 and 720, 722, 724, 726, 728, and 730 on FIG. 7 representing documents. In a further embodiment, the icons are dynamically linked to the documents they represent, such that the researcher may view the full version of the document retrieved from the database 212 or storage module 230.

Returning to FIG. 4, the completed research progression summary needs to be stored 415. The research progression summary can be stored in the storage module 234. Finally, the stored, completed research progression may be communicated 416. Means of communication are well known in the art and do not need to be discussed at length. In one embodiment, the research progression summary would be communicated via a user interface.

Turning next to FIG. 5, a block diagram of the method used to create a clustered-ranked-citation link graph. The clustered-ranked citation link graph is built using document information, retrieved by the retrieving module 220. This information is received by the clustered-ranked citation link graph generator 222 in step 512. The clustered-ranked citation link graph is built using a combination of three operations. The three operations are, categorizing identified documents into domains and sub-domains 514, generating a static rank for each document 516, and generating a citation link graph 518, all operations occur more or less simultaneously. In an illustrative embodiment, the citation link graph is a table where each document has a unique identifier and a plurality of document information is associated with the unique identifier. One having ordinary skill in the art will be familiar with methods of generating citation link graphs.

In an illustrative embodiment, the static rank for each document is calculated by determining how many times an individual document is cited in other documents. Finally, in an illustrative embodiment, each document is classified into one or more subject matter domains or sub-domains. In an illustrative embodiment the classification occurs by evaluating document information. The domain or sub-domain classification is then included in a field associated with the unique document identifier in the citation link graph.

The clustered-ranked citation link graph allows computations to be run over the graph that can then be used to produce a research progression summary. The clustered-ranked citation link graph makes it possible to determine the relative age of the documents, because older documents can't cite new documents. Additionally, the number of citations per documents and domain or sub-domain of the citing documents is also apparent. Further, the domain or sub-domain of each document within the clustered-ranked citation link graph is also apparent.

The completed clustered ranked citation link graph is then stored 522, and available for use in generating the research progression summary. In one embodiment the clustered-ranked citation link graph is stored in the storage module 234.

Turning next to FIG. 8, a schematic of a clustered ranked citation link graph. The large circles 860, 870, 880 represent sub-domains within the clustered ranked citation link graph 800. The links between the documents 850 indicate when a document has been cited within another document. Just as in FIG. 3 the size of the documents represents importance, and the shape represents the research sub-domain. Documents 810, 812, 814, 830, 832, 834, 840, 842, and 844 are merely representative of the types of documents that could be included and do not represent specific documents. Unlike in FIG. 3, the significance and sub-domain membership of the documents are readily apparent because of its placement in the clustered ranked citation link graph. The formation of the clustered ranked citation link graph allows the research progression summary generator to gather much of the information it needs about the documents in order to determine which documents to include in the summary.

The present invention has been described in relation to particular embodiments, which are intended in all respects to be illustrative rather than restrictive. Alternative embodiments will become apparent to those of ordinary skill-in-the-art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of generating a research progression summary for a particular research field, the method comprising:
receiving one or more research criteria;
identifying one or more documents that satisfies the one or more research criteria; generating the research progression summary utilizing the one or more identified documents; and
storing the generated research progression summary.

2. The one or more computer-readable media of claim 1, wherein the research progression summary includes a plurality of significant documents related to the particular field of research, and wherein a chronology of the plurality of significant documents is apparent.

3. The one or more computer-readable media of claim 2, wherein the research progression summary includes a greater number of documents dated after a predetermined threshold date than before the predetermined threshold date such that the plurality of significant documents represents a current state of the particular research field.

4. The one or more computer-readable media of claim 1, wherein the one or more research criteria are selected from the group consisting of one or more keywords, one or more known documents, one or more a domain hierarchies, and one or more sub-domain hierarchies.

5. The one or more computer-readable media of claim 1, wherein the method further comprises presenting the research progression summary.

6. The one or more computer-readable media of claim 5, wherein each of the one or more documents is represented by a graphical representation, and wherein the graphical representations are presented so that a chronology of the one or more documents is apparent.

7. The one or more computer-readable media of claim 6, wherein at least one of the graphical representations is dynamically linked to the document represented thereby.

8. The one or more computer-readable media of claim 1, further comprising communicating the research progression summary.

9. One or more computer-readable media having computer-executable instructions embodied thereon for performing a method of generating a clustered-ranked-citation link graph, the method comprising:
receiving document information for one or more documents; generating a citation link graph for the one or more documents;
categorizing the one or more documents into one or more domains;
generating a static rank for each of the one or more documents; and
storing a clustered-ranked-citation link graph.

10. The one or more computer-readable media of claim 9, wherein the method further comprises generating a research progression summary utilizing the clustered-ranked-citation link graph.

11. The one or more computer-readable media of claim 10, wherein the research progression summary includes a plurality of significant documents in a particular field of research, and wherein a chronology of the plurality of significant documents is apparent.

12. The one or more computer-readable media of claim 11, wherein the plurality of significant documents includes a greater number of significant documents dated prior to a predetermined date than dated after the predetermined date such that the plurality of significant documents represents a current state of the particular research field.

13. The one or more computer-readable media of claim 9, wherein at least one of the one or more documents is represented by a graphical representation, and wherein the graphical representations are presented so that a chronology of the one or more documents is apparent.

14. The one or more computer-readable media of claim 13, wherein at least one of the graphical representations is dynamically linked to the document represented thereby.

15. A computerized system for generating a research progression summary relevant to a particular topic, the system comprising:
a receiving module configured for receiving one or more research criteria;
a retrieving module configured for retrieving document information from one or more documents;
a generating module configured to generate a clustered-ranked-citation link graph;
a research progression summary generating module configured to generate a research progression summary; and
at least one storage module configured for storing at least document information from one of the one or more documents and the research progression summary.

16. The computerized system claim of 15, further comprising a communication module configured to communicate the research progression summary.

17. The computerized system of claim of 15, wherein the research progression generating module is configured to customize a progression of research relevant to the particular topic based on weighting research criteria.

18. The computerized system of claim of 17, wherein the weighting research criteria includes at least the date of publication and research field classification.

19. The computerized system of claim 15, further comprising a graphical-representation generating module configured to present the one or more documents represented by the research progression summary as graphical representations, the graphical representations being presented so that a chronology of the one or more documents is apparent.

20. The computerized system of claim 19, further comprising a linking module configured to dynamically link one or more of the graphical representations to the document represented thereby.
